(19) United States
(12) Patent Application Publication
(10) Pub. No.: US 2026/0279670 A1
(43) Pub. Date: Sep. 17, 2026

(54) MULTILAYER CERAMIC CAPACITOR AND MANUFACTURING METHOD THEREOF

(71) Applicant: SAMSUNG ELECTRO-MECHANICS CO., LTD., Suwon-si (KR)

(72) Inventors: Jinwoo Kim, Suwon-si (KR); Hyoju Lee, Suwon-si (KR); Sanghyun Lee, Suwon-si (KR); Tae Hyung Kim, Suwon-si (KR)

(73) Assignee: SAMSUNG ELECTRO-MECHANICS CO., LTD., Suwon-si (KR)

(21) Appl. No.: 19/393,424

(22) Filed: Nov. 18, 2025

(30) Foreign Application Priority Data
Mar. 14, 2025 (KR) 10-2025-0033139

(51) Int. Cl. H01G 4/12; H01G 4/008; H01G 4/012; H01G 4/30

(52) U.S. Cl. CPC H01G 4/1227; H01G 4/008; H01G 4/012; H01G 4/30

(57) ABSTRACT

A multilayer ceramic capacitor may include a capacitor body including a dielectric layer and an internal electrode layer, and an external electrode disposed on an outer side of the capacitor body, where the dielectric layer may include a grain boundary disposed between a plurality of dielectric grains and the plurality of dielectric grains, the dielectric layer may include Sn and a transition metal, at least one among the plurality of dielectric grains has a core-shell structure including a core portion, a first shell portion disposed on at least a portion of the core portion, and a second shell portion disposed on at least a portion of the first shell portion, and a content of the Sn and a content of the transition metal are largest in the first shell portion among the core portion, the first shell portion, the second shell portion, and the grain boundary.

### CROSS-REFERENCE TO RELATED APPLICATION

This application claims priority to and the benefit of Korean Patent Application No. 10-2025-0033139 filed with the Korean Intellectual Property Office on Mar. 14, 2025, the entire contents of which is incorporated herein by reference.

### BACKGROUND

The present disclosure relates to a multilayer ceramic capacitor and a method for manufacturing the same.

Electronic components using ceramic materials include capacitors, inductors, piezoelectric elements, varistors, or thermistors. Among ceramic electronic components, a multilayer ceramic capacitor (MLCC) may be used in various electronic devices due to advantages such as a small size, a high capacitance, an easy mounting feature, and the like.

For example, multilayer ceramic capacitor may be used in a condenser in the form of a chip that is mounted on a substrate of various electronic products, such as an image device such as liquid crystal display (LCD), plasma display device panel, an organic light emitting diode (OLED), a computer, a personal portable terminal and a smart phone, to charge and discharge electricity.

Recently, with the miniaturization of electronic products, multilayer ceramic capacitors are also required to be miniaturized and to have ultra-high capacitance. For this purpose, the thickness of the dielectric layer and internal electrode layer is reduced, and a multilayer ceramic capacitor having a structure in which a greater number of dielectric layers and internal electrode layers are stacked is being developed. These ultra-small and ultra-high-capacitance multilayer ceramic capacitors are recently used in fields that require a high level of reliability, such as electric vehicles, and accordingly, high stability and high reliability are required for such capacitors.

### SUMMARY

The present disclosure attempts to provide a multilayer ceramic capacitor having improved reliability.

The present disclosure also attempts to a manufacturing method of a multilayer ceramic capacitor.

A multilayer ceramic capacitor may include a capacitor body including a dielectric layer and an internal electrode layer, and an external electrode disposed on an outer side of the capacitor body, where the dielectric layer may include a grain boundary disposed between a plurality of dielectric grains and the plurality of dielectric grains, the dielectric layer may include Sn and a transition metal, at least one of the plurality of dielectric grains may have a core-shell structure including a core portion, a first shell portion disposed on at least a portion of the core portion, and a second shell portion disposed on at least a portion of the first shell portion, and a content of the Sn and a content of the transition metal may be largest in the first shell portion among the core portion, the first shell portion, the second shell portion, and the grain boundary.

In a linear section from a center of the dielectric grain having the core-shell structure to the grain boundary, a length corresponding to the core portion may be 20 nm to 80 nm, a length corresponding to the first shell portion may be 10 nm to 60 nm, a length corresponding to the second shell portion may be 10 nm to 60 nm, and a length corresponding to the grain boundary may be 5 nm or less.

In a linear section extending from a first grain boundary to a second grain boundary of the dielectric grain having the core-shell structure and passing through a central point of the dielectric grain, Equations 1 to 3 may be satisfied,

$$0.85 a \leq b + c \leq 1.15 a , \qquad [ Equation 1 ]$$

$$0.1 a \leq b \leq 0.9 a , \qquad [ Equation 2 ]$$

$$0.1 a \leq c \underline{<} 0.9 a , \qquad [ Equation 3 ]$$

where, a is a length from the first grain boundary to the second grain boundary, b is a length corresponding to the core portion in the linear section, and c is a total length of the second shell portion in the linear section.

The transition metal included in the dielectric layer may include at least one selected from the group consisting of Mn, V, Cr, Ta, Sc, Ti, Fe, Co, Ni, Cu and Zn.

The dielectric layer may further include one or more selected from selected from the group consisting of rare-earth elements and Si.

The dielectric layer may include the rare-earth element, and the content of the rare-earth element may be largest in the second shell portion among the core portion, the first shell portion, the second shell portion, and the grain boundary.

The dielectric layer may include the Si, and the content of the Si may be largest in the grain boundary among the core portion, the first shell portion, the second shell portion, and the grain boundary.

A content of the transition metal included in the first shell portion may be 1.2 times or more of a content of the transition metal included in the grain boundary.

The dielectric grain having the core-shell structure may further include a third shell portion disposed on at least a portion of the second shell portion.

A content of the transition metal included in the third shell portion may be 0.01 times to 0.2 times of a content of the transition metal included in the first shell portion. The dielectric layer may further include one or more selected from among rare-earth elements and Si.

The dielectric layer may include the rare-earth element, and a content of the rare-earth element included in the third shell portion may be 0.01 times to 0.2 times of a content of the rare-earth element included in the second shell portion.

The dielectric layer may include the rare-earth element, and a content of the rare-earth element included in the grain boundary may be 1.3 times or more of a content of the rare-earth element included in the third shell portion.

An average thickness of the dielectric layer may be greater than 0 μm and less than or equal to 0.7 μm.

An average thickness of the dielectric layer may be greater than 0 μm and less than or equal to 0.65 μm.

A manufacturing method of the multilayer ceramic capacitor according to the present disclosure may include manufacturing a dielectric powder doped with Sn and the transition metal in a barium titanate-based compound, manufacturing a dielectric slurry including the dielectric powder, manufacturing a dielectric green sheet by using the dielectric slurry, and forming a conductive paste layer on the dielectric green sheet surface, manufacturing a dielectric material green sheet laminate by stacking the dielectric green sheet on which the conductive paste layer is formed, manufacturing the capacitor body including the dielectric layer and the internal electrode layer by firing the dielectric material green sheet laminate, and forming the external electrode on a first surface of the capacitor body.

A doping amount of Sn may be 0.1 parts by mole to 5 parts by mole based on the 100 parts by mole of the barium titanate-based compound.

A doping amount of the transition metal may be 0.01 parts by mole to 0.5 parts by mole based on the 100 parts by mole of the barium titanate-based compound.

The dielectric slurry may further include a transition metal-containing compound. A rare-earth element may be further doped into the barium titanate-based compound.

According to some embodiments of the present disclosure, the breakdown voltage characteristics of a dielectric layer may be improved, and the driving reliability and high voltage stability of a multilayer ceramic capacitor may be improved. In addition, a transition metal may be sufficiently dispersed within dielectric layer, so that the dielectric and capacitance characteristics can be improved.

### BRIEF DESCRIPTION OF THE DRAWINGS

FIG. 1 is a perspective view showing a multilayer ceramic capacitor according to an embodiment.

FIG. 2 is a cross-sectional view of a multilayer ceramic capacitor taken along line I-I′ of FIG. 1.

FIG. 3 is a cross-sectional view of a multilayer ceramic capacitor taken along line II-II′ of FIG. 1.

FIG. 4 is a schematic view conceptually illustrating dielectric grains of a multilayer ceramic capacitor according to an embodiment.

FIG. 5 is a transmission electron microscopy-energy dispersive X-ray spectroscopy (TEM-EDS) analysis image for dielectric grains of a multilayer ceramic capacitor according to Example 1.

FIG. 6 are TEM analysis image and line scanning analysis result for a dielectric grain of a multilayer ceramic capacitor according to Example 1.

FIG. 7 are TEM-EDS analysis images for a dielectric grain of a multilayer ceramic capacitor according to Example 1.

### DETAILED DESCRIPTION OF THE EMBODIMENTS

The present disclosure will be described more fully hereinafter with reference to the accompanying drawings, in which embodiments of the disclosure are shown. The drawings and description are to be regarded as illustrative in nature and not restrictive. Like reference numerals designate like elements throughout the specification. Further, some constituent elements in the drawings may be exaggerated, omitted, or schematically illustrated, and a size of each constituent element does not reflect the actual size entirely.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like will be used only to describe various constituent elements, and are not to be interpreted as limiting these constituent elements. The terms are only used to differentiate one constituent element from other constituent elements.

It will be understood that when an element such as a layer, film, region, area, or substrate is referred to as being “on” or “above” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

Throughout the specification, it should be understood that the term “include,” “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case in which respective parts that are substantially integrated are linked to each other.

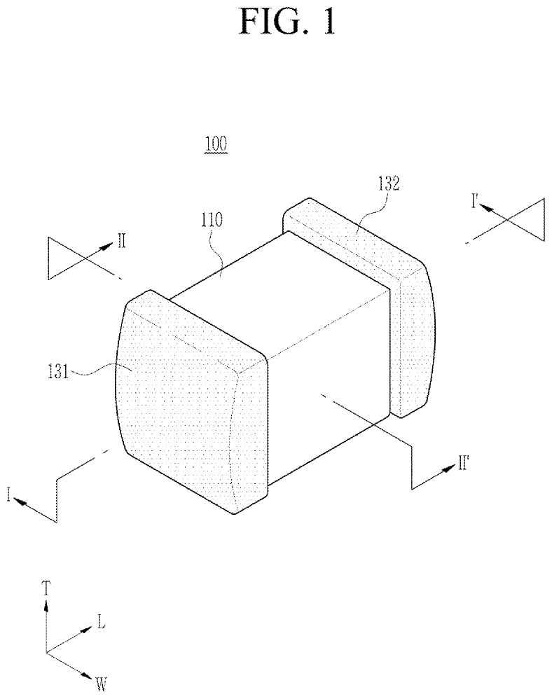

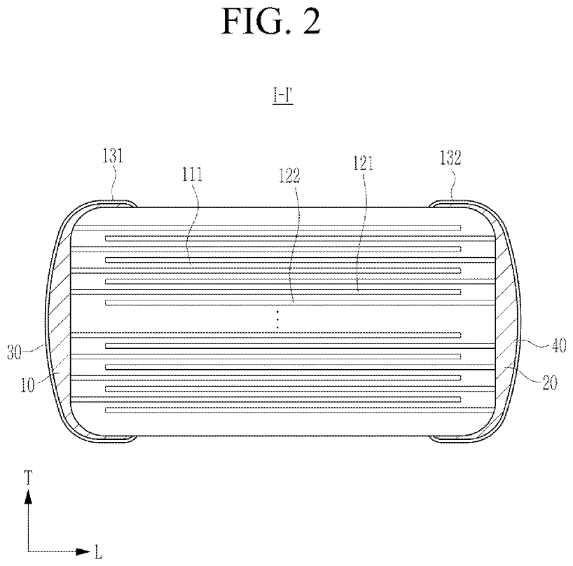

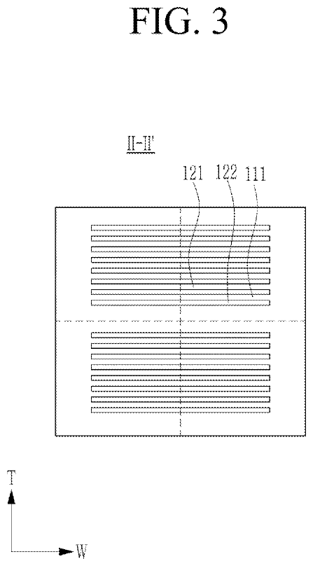

FIG. 1 is a perspective view conceptually showing a multilayer ceramic capacitor according to an example. FIG. 2 is a conceptual cross-sectional view of a multilayer ceramic capacitor taken along line I-I′ of FIG. 1. FIG. 3 is a conceptual cross-sectional view of a multilayer ceramic capacitor taken along line II-II′ of FIG. 1.

Referring to FIG. 1 to FIG. 3, a multilayer ceramic capacitor 100 may include a capacitor body 110 and external electrodes 131 and 132 disposed on an outer side of the capacitor body 110. The external electrodes 131 and 132 may include a first external electrode 131 and a second external electrode 132 disposed at both ends facing each other in a length direction (L-axis direction) of the capacitor body 110.

The L-axis, W-axis and T-axis shown in FIG. 1 to FIG. 3 represent a length direction, a width direction, and a stacking direction of the capacitor body 110, respectively. Here, the stacking direction (T-axis direction) may be a direction perpendicular to wide surfaces (major surfaces) of the sheet-shaped components, and as an example, may be used as the same concept as a direction in which a dielectric layer 111 is stacked. The length direction (L-axis direction) may be a direction generally perpendicular to the stacking direction (T-axis direction) in a direction extending parallel to wide surfaces (major surface) of the sheet-shaped components, and as an example, may be a direction in which the first external electrode 131 and the second external electrode 132 are located on both sides. The width direction (W-axis direction) may be a direction generally perpendicular to the stacking direction (T-axis direction) and the length direction (L-axis direction) in a direction extending parallel to wide surfaces (major surface) of the sheet-shaped components, and the lengths of the sheet-shaped components in the length direction (L-axis direction) may be greater than the lengths in the width direction (W-axis direction).

In some embodiments, the capacitor body 110 may include a generally hexahedral shape.

Hereinafter, for convenience of description, in the capacitor body 110, both surfaces facing each other in the stacking direction (T-axis direction) may be defined as a first surface and a second surface, both surfaces connected to the first surface and the second surface and facing each other in the length direction (L-axis direction) may be defined as a third surface and a fourth surface, both surfaces connected to the first surface and the second surface, connected to the third surface and the fourth surface, and facing each other in the width direction (W-axis direction) may be defined as a fifth surface and a sixth surface.

The first surface, which is a lower surface of the capacitor body 110, may be a surface facing a mounting direction of the multilayer ceramic capacitor 100. At least one of the first surface to the sixth surface may be flat. Alternatively, at least one of the first surface to the sixth surface may be a curved surface with a convex central portion, and an edge, which is a boundary of each surface may be rounded.

The shape and size of the capacitor body 110 and the number of stacks of the dielectric layer 111 are not limited to what is illustrated in the drawings of the present disclosure.

The capacitor body 110 may include the dielectric layer 111 and internal electrodes 121 and 122. The capacitor body 110 may include a plurality of dielectric layers 111. The internal electrodes 121 and 122 may include a first internal electrode 121 and a second internal electrode 122 disposed alternately and repeatedly in the stacking direction (T-axis direction).

The capacitor body 110 may include the first internal electrode 121 and the second internal electrode 122 alternately disposed in the stacking direction (T-axis direction) interposing the plurality of dielectric layers 111, and the dielectric layer 111.

Boundaries between adjacent dielectric layers 111 may be integrated to the degree that it may be difficult to confirm without using scanning electron microscopy (SEM).

The capacitor body 110 may include an active region. The active region may be a portion that contributes to forming the capacitance of the multilayer ceramic capacitor 100. For example, the active region may be a region where the first internal electrode 121 or the second internal electrode 122 stacked along the stacking direction (T-axis direction) overlap with each other.

The capacitor body 110 may further include a cover region and a side margin region.

The cover region is a marginal portion in the stacking direction, and may be located to be adjacent to the first surface and the second surface of the active region in the stacking direction (T-axis direction), respectively. For example, a single the dielectric layer 111 or two or more dielectric layers 111 may be stacked on an upper surface and a lower surface of the active region, respectively, to be provided as the cover region.

The side margin region is a marginal portion in the width direction, and may be located to be adjacent to the fifth surface and the sixth surface of the active region in the width direction (W-axis direction), respectively. The side margin region may be formed by stacking the dielectric green sheets in which a conductive paste layer is applied to only a partial region of a dielectric green sheet surface, and the conductive paste layer is not applied to both side surfaces of the dielectric green sheet surface, and then firing it.

For example, through the cover region and the side margin region, the damage of the first internal electrode 121 and the second internal electrode 122 due to physical or chemical stress may be prevented.

The dielectric layer 111 may include a barium titanate-based compound as a primary component. For example, by using the barium titanate-based compound as a dielectric base material, dielectric characteristics of the multilayer ceramic capacitor 100 may be secured.

The barium titanate-based compound may include at least one selected from the group consisting of BaTiO₃, BaZrO₃, BaSnO₃, CaTiO₃, CaZrO₃, CaSnO₃, SrTiO₃, SrZrO₃, and SrSnO₃, or the like. These may be used alone or in combination of two or more. The dielectric layer 111 may further include a secondary component.

The secondary component may include at least one selected from the group consisting of tin (Sn), manganese (Mn), chromium (Cr), silicon (Si), aluminum (Al), magnesium (Mg), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), and vanadium (V), or the like. These may be used alone or in combination of two or more.

According to some embodiments of the present disclosure, the dielectric layer 111 may include Sn and a transition metal as the secondary component. Accordingly, even if a thickness of the dielectric layer 111 is relatively small, the breakdown voltage may be improved. Accordingly, the stability and reliability of the multilayer ceramic capacitor 100 may be improved.

The transition metal included in the dielectric layer 111 may include at least one selected from the group consisting of Mn, V, Cr, Ta, Sc, Ti, Fe, Co, Ni, Cu and Zn.

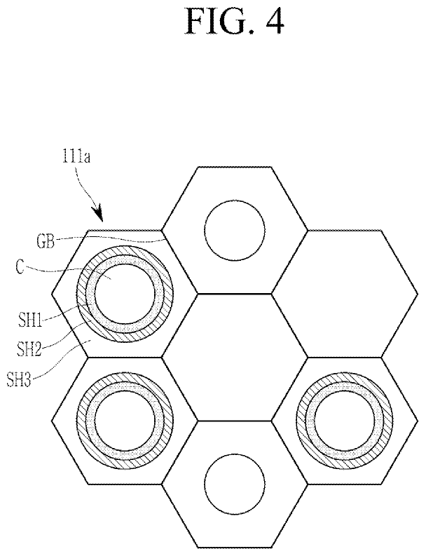

FIG. 4 is a schematic view conceptually illustrating dielectric grains of a multilayer ceramic capacitor according to an embodiment.

Referring to FIG. 4, the dielectric layer 111 may include a plurality of dielectric grains 111a and a grain boundary GB disposed between the plurality of dielectric grains 111a.

At least one among the plurality of dielectric grains 111a may have a core-shell structure.

The core-shell structure may include a core portion C, a first shell portion SH1 disposed on at least a portion of the core portion C, and a second shell portion SH2 disposed on at least a portion of the first shell portion SH1.

The core portion C may include the above-described barium titanate-based compound.

The first shell portion SH1 may include Sn and a transition metal. Accordingly, Sn and the transition metal can be sufficiently dispersed, so that the dielectric characteristics and the breakdown voltage characteristics of the dielectric grain 111a may be improved.

The content of Sn and the content of the transition metal may be largest in the first shell portion SH1 among the core portion C, the first shell portion SH1, the second shell portion SH2, and the grain boundary GB. Accordingly, the breakdown voltage characteristics of the dielectric layer 111 may be improved, so that the driving reliability and high-voltage stability of the multilayer ceramic capacitor 100 is improved. In addition, the transition metal may be sufficiently dispersed within the dielectric layer 111, so that the dielectric and capacitance characteristics may be improved.

The dielectric layer 111 may further include one or more selected from among rare-earth elements and Si.

In an example, the dielectric layer 111 may include a rare-earth element, and the content of the rare-earth element may be largest in the second shell portion SH2 among the core portion C, the first shell portion SH1, the second shell portion SH2, and the grain boundary GB. Accordingly, the increase in the insulation resistance according to the movement of oxygen vacancies may be further suppressed, and high-temperature life characteristics of the multilayer ceramic capacitor 100 may be further improved.

The rare-earth element may include at least one selected from the group consisting of Dy, Tb, Y, Gd, Ho, La, Er, Sm, Nd, and Ce, or the like. These may be included alone or in combination of two or more.

In an example, the dielectric layer 111 may include Si, and the content of the Si may be largest in the grain boundary GB among the core portion C, the first shell portion SH1, the second shell portion SH2, and the grain boundary GB. Accordingly, the stability between the plurality of dielectric grains 111a and the density of the dielectric layer 111 may be further improved, and the breakdown voltage characteristics and stability of the multilayer ceramic capacitor 100 may be further improved.

In the Comparative Example, the transition metal is added or coated after the growth of the dielectric grains, the content of the transition metal in the grain boundary may be greater than the content of the transition metal in the first shell portion. However, in embodiments of the present disclosure, the transition metal may be doped together at the time of the growth of the dielectric grain 111a, so that the content of the transition metal in the first shell portion SH1 may be greater than the content of the transition metal of the grain boundary GB. Accordingly, the transition metal may be stably distributed and the stability and reliability of the multilayer ceramic capacitor 100 may be improved.

In an example, the content of the transition metal of the first shell portion SH1 may be 1.2 times or more of the content of the transition metal included in the grain boundary GB. In another example, the content of the transition metal in the first shell portion SH1 may be 1.5 times to 3.0 times of the content of the transition metal included in the grain boundary GB. In the above range, the transition metal may be distributed sufficiently stably, so that the breakdown voltage characteristics of the multilayer ceramic capacitor 100 may be further improved. In this case, the transition metal may include Mn.

In another example, the dielectric grain 111a having the above-described core-shell structure may further include a third shell portion SH3 disposed on at least a portion of the second shell portion SH2. For example, an outermost portion of the third shell portion SH3 may be provided as the grain boundary GB.

The content of the transition metal included in the third shell portion SH3 may be smaller than or equal to 0.2 times of the content of the transition metal included in the first shell portion SH1, and in another example, may be 0.01 times to 2 times thereof. The content of the rare-earth element included in the third shell portion SH3 may be 0.2 times or less, or 0.05 times to 0.18 times of the content of the rare-earth element included in the second shell portion SH2. Accordingly, the transition metal is concentrated in the first shell portion SH1 so that the breakdown voltage characteristics may be improved further stably, and the rare-earth element is concentrated in the second shell portion SH2 so that the increase in the insulation resistance may be further suppressed.

In an example, the content of the rare-earth element included in the grain boundary GB may be 1.3 times or more, or 1.4 times to 2.0 times of the content of the rare-earth element included in the third shell portion SH3. Accordingly, the stability in the interface between the plurality of dielectric grains 111a may be further improved, and the life characteristics may be further improved.

The term “content” as used herein can be proportional to the signal intensity of an element according to TEM-EDS analysis and line scanning analysis.

For example, a cross-section (L-T cross-section) cut in the length direction (L-axis direction) and the stacking direction (T-axis direction) perpendicular to the width direction at a center of the multilayer ceramic capacitor 100 in the width direction (W-axis direction) may be exposed. The multilayer ceramic capacitor 100 may be fixed by an epoxy resin, and may be polish by a polishing machine, so that the L-T cross-section may be exposed. The polishing may be performed so that ½ of the length in the width direction (W-axis direction) is deleted. In the exposed L-T cross-section, the active region may be divided into three parts of an upper portion, a central portion, and a lower portion, and one dielectric layer 111 may be selected for each part. For each selected dielectric layer 111, three dielectric crystal grains 111a may be randomly selected (a total of nine dielectric crystal grains can be selected). An TEM analysis image can be obtained for the selected dielectric grains 111a, respectively, and a linear section extending from a first grain boundary GB to a second grain boundary of the dielectric grain 111a and passing through a central point of the dielectric grain 111a may be set in the TEM analysis image. In the linear section, a point with the highest content of Si may be evaluated as the grain boundary GB. In the linear section, a region where the content of Sn and the transition metal, and the content of the rare-earth element are smallest together may be evaluated as the core portion C. In the linear section, a region with the largest content of Sn and the transition metal may be evaluated as the first shell portion SH1. In the linear section, a region with the largest content of the rare-earth element may be evaluated as the second shell portion SH2. When a length from the first grain boundary GB to the second grain boundary GB is denoted as “a”, a length corresponding to the core portion C in the linear section is denoted as “b”, a total length corresponding to the second shell portion SH2 in the linear section is denoted as c, Equation 1 to Equation 3 below may be satisfied.

$$0.85 a \leq b + c \leq 1.15 a \qquad [ Equation 1 ]$$

$$0.1 a \leq b \leq 0 \text{.9} a \qquad [ Equation 2 ]$$

$$0.1 a \leq c \underline{<} 0 \text{.9} a \qquad [ Equation 3 ]$$

In an example, a region between the grain boundary GB and the second shell portion SH2 may be evaluated as the third shell portion SH3.

The existence and position of the dielectric grain 111a may also be confirmed through an transmission electron microscopy-energy dispersive X-ray spectroscopy (TEM-EDS) analysis. For example, a Ba-rich region may be evaluated as the core portion C, a Sn and transition metal-rich region may be evaluated as the first shell portion SH1, and a rare-earth element-rich region may be evaluated as the second shell portion SH2.

In a linear section from the center to the grain boundary GB of the dielectric grain 111a having the core-shell structure, the length corresponding to the core portion C may be 20 nm to 80 nm, and a length corresponding to the first shell portion SH1 may be 10 nm to 60 nm, and a length corresponding to the second shell portion SH2 may be 10 nm to 60 nm, and a length corresponding to the grain boundary GB may be 5 nm or less. The third shell portion SH3 may be a region disposed between the second shell portion SH2 and the grain boundary GB.

By synthesizing the length of the linear section and the TEM-EDS analysis result, the core portion C, the first shell portion SH1, the second shell portion SH2, the third shell portion SH3 and existence and position of the grain boundary GB can be finally determined.

According to an example, average thickness (T-axis direction average length) of the dielectric layer 111 may be greater than 0 μm and less than or equal to 7.0 μm. According to another example, the average the thickness of the dielectric layer 111 may be greater than 0 μm and less than or equal to 0.65 μm. In the above ranges, the multilayer ceramic capacitor 100 can be maintained or improved while being sufficiently thinned and made denser.

For example, the average thickness of the dielectric layer 111 may be based on a central point of the dielectric layer 111 in the length direction (L-axis direction) or the width direction (W-axis direction), in a scanning electron microscopy (SEM) analysis image of a cross-section (L-T cross-section) taken along the length direction (L-axis direction) and the stacking direction (T-axis direction) to be perpendicular to the width direction at a center of the multilayer ceramic capacitor 100 in the width direction (W-axis direction), and may be obtained as an arithmetic average value of thicknesses of the dielectric layer 111 measured at 10 points away from the reference point by a predetermined interval. The interval of the 10 points may be adjusted depending on the scale of the SEM image, and for example, may be an interval of 1 μm to 100 μm, 1 μm to 50 μm, or 1 μm to 10 μm. At this time, all the 10 points must be located within the dielectric layer 111, and when all the 10 points are not located within the dielectric layer 111, the location of the reference point may be changed, or the interval between the 10 points may be adjusted.

The first internal electrode 121 and the second internal electrode 122 may have different polarities. For example, the first internal electrode 121 and the second internal electrode 122 may be alternately disposed to face each other along the T-axis direction interposing the dielectric layer 111. For example, a first end of the first internal electrode 121 may be exposed through the third surface of the capacitor body 110, and a first end of the second internal electrode 122 may be exposed through the fourth surface of the capacitor body 110.

The first internal electrode 121 and the second internal electrode 122 may be electrically insulated by the dielectric layer 111 disposed therebetween.

An end portion of the first internal electrode 121 exposed through the third surface of the capacitor body 110 may be electrically connected to the first external electrode 131. For example, an end portion of the second internal electrode 122 exposed through the fourth surface of the capacitor body 110 may be electrically connected to the second external electrode 132.

The first internal electrode 121 and the second internal electrode 122 may include a conductive metal, respectively. For example, the conductive metal may include a metal such as Ni, Cu, Ag, Pd, or Au, or an alloy thereof (e.g., Ag—Pd alloy).

The first internal electrode 121 and the second internal electrode 122 may include dielectric particles of the same composition as the ceramic material included in the dielectric layer 111.

The first internal electrode 121 and the second internal electrode 122 may be formed by using a conductive paste including a conductive metal. For example, the conductive paste may be printed through a screen printing or gravure printing method.

According to an example, an average thickness of the first internal electrode 121 and the second internal electrode 122 may be 0.1 μm to 2 μm. In the above range, the resistance may be further reduced as the multilayer ceramic capacitor 100 becomes further miniaturized and thinner.

The average thickness of the first internal electrode 121 and the second internal electrode 122 may be measured by the SEM analysis. The SEM analysis may be substantially the same as the above-described method for measuring the average thickness of the dielectric layer 111.

The capacitor body 110 may be formed by firing a laminate in which the plurality of dielectric layers 111 and the internal electrodes 121 and 122 are stacked.

Referring to FIG. 2, the first external electrode 131 and the second external electrode 132 may have different polarities.

The first external electrode 131 may be in contact with and electrically connected to a portion where the first internal electrode 121 is exposed. For example, the second external electrode 132 may be in contact with and electrically connected to a portion where the second internal electrode 122 is exposed.

When a predetermined voltage is applied to the first external electrode 131 and the second external electrode 132, charges may be may accumulated between the first internal electrode 121 and the second internal electrode 122 facing each other. The capacitance of the multilayer ceramic capacitor 100 may be proportional to an overlapping area in a plan view of the first internal electrode 121 and the second internal electrode 122 that overlap with each other in the stacking direction (T-axis direction) in the active region.

The first external electrode 131 and the second external electrode 132 may include first and second connection portions (not shown) disposed on the third surface and the fourth surface of the capacitor body 110, respectively, and connected to the first internal electrode 121 and the second internal electrode 122, respectively. The first external electrode 131 and the second external electrode 132 may include first and second band portions (not shown) disposed on edges where the third surface and the fourth surface, the first surface and the second surface, or the fifth surface and the sixth surface of the capacitor body 110 meet each other, respectively.

The first and second band portions may extend from the first and second connection portions to a part of the first surface and the second surface or a part of the fifth surface and the sixth surface of the capacitor body 110, respectively. The fixing strength of the first external electrode 131 and the second external electrode 132 may be improved through the first and second band portions.

The external electrodes 131 and 132 may include electrode layers 10 and 20 located on the surface of the capacitor body 110.

The first external electrode 131 may include a first electrode layer 10 located directly on the surface (e.g., the third surface) of the capacitor body 110 and electrically connected to the first internal electrode 121. For example, the second external electrode 132 may include a second electrode layer 20 located directly on the surface (e.g., the fourth surface) of the capacitor body 110 and electrically connected to the second internal electrode 122.

The electrode layers 10 and 20 may include a conductive metal and glass.

The conductive metal may include at least one selected from the group consisting of copper (Cu), nickel (Ni), silver (Ag), palladium (Pd), gold (Au), platinum (Pt), tin (Sn), tungsten (W), titanium (Ti), lead (Pb), an alloy thereof, and a combination thereof—for example, copper (Cu) may include a copper (Cu) alloy. When the conductive metal contains copper, a metal other than copper may be contained in an amount of no more than 5 parts by mole based on 100 parts by mole of copper.

The glass may include a composition containing a mixture of oxides, for example, may be one or more selected from the group consisting of silicon oxide, boron oxide, aluminum oxide, the transition metal oxide, alkali metal oxide, and alkaline-earth metal oxide.

The transition metal may be selected from the group consisting of zinc (Zn), titanium (Ti), copper (Cu), vanadium (V), manganese (Mn), iron (Fe), and nickel (Ni), the alkali metal may be selected from a group consisting of lithium (Li), sodium (Na), and potassium (K), and alkaline-earth metal may be one or more selected from the group consisting of magnesium (Mg), calcium (Ca), strontium (Sr), and barium (Ba).

According to an example, the external electrodes 131 and 132 may further include plating layers 30 and 40 located on the electrode layers 10 and 20.

The external electrodes 131 and 132 may further include, optionally, a conductive resin layer (not shown) located between the electrode layers 10 and 20 and the plating layers 30 and 40.

The conductive resin layer may extend to the first surface and the second surface, or the fifth surface and the sixth surface of the capacitor body 110. In this case, a length of a region (e.g., band portion) where the conductive resin layer is disposed may be longer than a length of a region (e.g., band portion) where the electrode layers 10 and 20 are disposed to extend to the first surface and the second surface, or the fifth surface and the sixth surface of the capacitor body 110. For example, the conductive resin layer may entirely cover the electrode layers 10 and 20.

The conductive resin layer may include a resin and a conductive member.

The resin is not particularly limited, if it has bondability and shock absorbing properties and is capable of being mixed with the conductive member powder to create a paste, and may include, for example, a phenol resin, an acryl resin, a silicone resin, an epoxy resin, or a polyimide resin.

The conductive member may be electrically connected to the internal electrodes 121 and 122 or the electrode layers 10 and 20.

The conductive member may have a spherical shape, a flake shape, or a combination thereof. For example, the conductive member may be formed only in the flake shape or only in the spherical shape, and may include a mixed shape of the flake shape and the spherical shape.

The spherical shape may include a shape that is not perfectly spherical shape, and for example, may include a shape in which a length ratio of a major axis and a minor axis (i.e., major axis/minor axis) is less than or equal to 1.45. The flake-shaped powder refers to a powder having a flat and elongated shape, and for example, a length ratio of a major axis and a minor axis (i.e., major axis/minor axis) may be greater than or equal to 1.95, although not limited thereto.

The external electrodes 131 and 132 may further include the plating layers 30 and 40 disposed to cover the above-described conductive resin layer.

The plating layers 30 and 40 may include a first plating layer 30 disposed on the first electrode layer 10 and a second plating layer 40 disposed on the second electrode layer 20.

The plating layers 30 and 40 may include nickel (Ni), copper (Cu), tin (Sn), palladium (Pd), platinum (Pt), gold (Au), silver (Ag), tungsten (W), titanium (Ti), lead (Pb), an alloy thereof, or the like. These may be used alone or in combination of two or more.

The plating layers 30 and 40 may be a nickel (Ni) plating layer or a tin (Sn) plating layer. For example, the plating layers 30 and 40 may include the form in which a nickel (Ni) plating layer and a tin (Sn) plating layer are sequentially stacked or the form in which a tin (Sn) plating layer, a nickel (Ni) plating layer, and a tin (Sn) plating layer are sequentially stacked. For example, the plating layers 30 and 40 may include a plurality of nickel (Ni) plating layers and/or a plurality of tin (Sn) plating layers.

Through the plating layers 30 and 40, mountability on a substrate, structural reliability, durability against external impact, heat resistance, and equivalent series resistance (ESR) of the multilayer ceramic capacitor 100 may be improved.

Hereinafter, a method of manufacturing the multilayer ceramic capacitor 100 according to an embodiment will be described.

A method for preparing the multilayer ceramic capacitor 100 may include manufacturing the capacitor body 110 including the dielectric layer 111 and the internal electrodes 121 and 122, and forming the external electrodes 131 and 132 on the outer side of the capacitor body 110.

In the manufacturing process of the capacitor body 110, a dielectric slurry that becomes the dielectric layer 111 after firing and a conductive paste that becomes the internal electrodes 121 and 122 after firing may be prepared.

A calcined powder may be obtained by uniformly mixing and drying the dielectric powder through wet mixing or the like, and then by heat-treating under a predetermined condition. An organic vehicle or an aqueous vehicle may be added to the calcined powder, which may be then heated and mixed to prepare the dielectric slurry.

The dielectric powder can be manufactured by doping the above-described barium titanate-based compound with Sn and the transition metal.

The doping may be performed through a hydrothermal synthesis method or a solid-phase synthesis method. The hydrothermal synthesis method may refer to a doping method performed by adding a raw material to water under conditions of 100° C. and 1 atm or higher. The solid-state synthesis method may refer to a doping method performed by mixing multiple types of raw material powders.

A doping amount of the Sn may be 0.1 parts by mole to 5 parts by mole based on the 100 parts by mole of the barium titanate-based compound. A doping amount of the transition metal may be 0.01 parts by mole to 0.5 parts by mole with respect to the 100 parts by mole of the barium titanate-based compound. In the above doping amount ranges, the first shell portion of the above-described the dielectric grain can be formed sufficiently stably, and the guaranteed voltage of the multilayer ceramic capacitor 100 may be further improved.

In an example, the dielectric slurry may further include a transition metal-containing compound as an additive. Accordingly, the content of the transition metal in the first shell portion of the dielectric grain may be further improved. Accordingly, the reliability and stability of the multilayer ceramic capacitor 100 may be improved.

The transition metal-containing compound may include, for example, Mn₃O₄.

The dielectric slurry may be formed into a sheet by a technique such as a doctor blade method, to obtain the dielectric green sheet. For example, the dielectric slurry may include an additive selected from various dispersants, a plasticizer, a dielectric material, a secondary component compound, glass, and/or the like.

The conductive paste for an internal electrode may be prepared by mixing a conductive powder made of a conductive metal or an alloy thereof with a binder or solvent.

The conductive paste for an internal electrode may include indium (In).

The conductive paste for an internal electrode may include ceramic powder (e.g., barium titanate powder) as a co-material. The co-material may inhibit sintering of the conductive powder during the firing process.

The conductive paste for an internal electrode may be applied to the dielectric green sheet surface in a predetermined pattern by using various printing methods such as screen printing or a transfer method. The dielectric green sheet laminate may be obtained by stacking the dielectric green sheets having internal electrode patterns in a plurality of layers and by pressurizing it in the stacking direction. The dielectric green sheet and the internal electrode pattern may be stacked so that the dielectric green sheet may be located on an upper surface and a lower surface of the dielectric green sheet laminate in the stacking direction.

Optionally, the dielectric green sheet laminate may be cut to a predetermined size by dicing or the like.

The dielectric green sheet laminate may be solidified and dried to remove plasticizers or the like, if necessary, and after solidifying and drying, may be barrel polished by using horizontal centrifugal barrel machine, or the like. In the barrel polishing, the dielectric green sheet laminate is placed into a barrel container together with media and polishing liquid, and rotational motion, vibration, or the like is applied to the barrel container, to polish unnecessary portions such as burr generated during cutting. For example, after the barrel polishing, the dielectric green sheet laminate may be washed with a cleaning solution such as water and dried.

The dielectric green sheet laminate may be subjected to binder removal treatment and firing treatment, to obtain the capacitor body 110.

The conditions for the binder removal treatment may be appropriately adjusted according to the composition of the primary component of the dielectric layer or the composition of the primary component of the internal electrode. For example, at the time of the binder removal treatment, the temperature increasing rate may be 5° C./hour to 300° C./hour, the support temperature may be 180° C. to 400° C., and the temperature maintaining time may be 0.5 hours to 24 hours. The binder removal atmosphere may be air or a reducing atmosphere.

The conditions for the firing treatment may be appropriately adjusted according to the composition of the primary component of the dielectric layer or the composition of the primary component of the internal electrode. For example, the temperature during firing may be 1200° C. to 1350° C., or 1220° C. to 1300° C., and the time may be 0.5 hours to 8 hours, or 1 hour to 3 hours. The firing atmosphere may be a reducing atmosphere, and for example, an atmosphere of a humidified mixture of nitrogen gas (N₂) and hydrogen gas (H₂). When the internal electrodes 121 and 122 include nickel (Ni) or a nickel (Ni) alloy, the oxygen partial pressure in firing atmosphere may be 1.0×10⁻¹⁴ MPa to 1.0×10⁻¹⁰ MPa.

After the firing treatment, annealing may be performed if necessary. The annealing is a treatment for re-oxidizing the dielectric layer, and the annealing may be performed in the case that the firing treatment was performed in a reducing atmosphere. The conditions for the annealing treatment may also be appropriately adjusted according to the composition of the primary component of the dielectric layer or the like. For example, the temperature at the time of annealing may be 950° C. to 1150° C., the time may be 0 hours to 20 hours, and temperature increasing rate may be 50° C./hour to 500° C./hour. The annealing atmosphere may be a humidified nitrogen gas (N₂) atmosphere, and oxygen partial pressure may be 1.0×10⁻⁹ MPa to 1.0×10⁻⁵ MPa.

In the binder removal treatment, the firing treatment, or the annealing treatment, in order to humidify nitrogen gas, mixed gas, or the like, for example, a wetter or the like may be used, and in this case, the water temperature may be 5° C. to 75° C. The binder removal treatment, the firing treatment, and the annealing treatment may be consecutively performed, and may be independently performed.

Optionally, the third surface and the fourth surface of the obtained capacitor body 110 may be subjected to surface treatment such as sandblasting treatment, laser irradiation, or barrel polishing. Through such surface treatment, end portions of the first internal electrode 121 and the second internal electrode 122 may be exposed on the surface of the third surface and the fourth surface. Accordingly, the electrical junction between the first external electrode 131 and the second external electrode 132 and the first internal electrode 121 and the second internal electrode 122 may be improved, and the alloy portion may be easily formed.

By forming the electrode layers 10 and 20 by applying a paste for forming an electrode layer on an outer surface of the capacitor body 110 and sintering it, the external electrodes 131 and 132 may be manufactured.

The paste for forming an electrode layer may include the conductive metal 11 and the glass composition.

The conductive metal may include an auxiliary element including at least one selected from the group consisting of Ni, and Sn, Al, Zn, In, and Co. An alloy of the auxiliary element and Ni may be formed according to sintering, and accordingly, the connection of the internal electrodes 121 and 122 and the external electrodes 131 and 132 may be improved.

The glass composition may include at least one selected from the group consisting of a Si oxide, an Al oxide, a Fe oxide, a Sn oxide, a Zn oxide, a Li oxide, a Na oxide, a K oxide, a Ba oxide, a Ca oxide, a Sr oxide, a B oxide, a Ni oxide, a Mn oxide, a Ge oxide, a Cu oxide, an In oxide, a Co oxide, a Ti oxide, and a P oxide.

For example, the glass composition may include at least one selected from the group consisting of Liₒ, Na₂O, K₂O, SiO₂, Al₂O₃, FeO, Fe₂O₃, Fe₃O₄, NiO, Ni₂O₃, Ni₃O₄, In₂O₃, TiO₂, P₂O₅, BaO, CaO, SrO, B₂O₃, ZnO, SnO, SnO₂, Cu₂O, CuO, CoO, Co₂O₃, GeO₂, MnO, Mn₂O, Mn₂O₃, Mn₃O₄, or the like. These may be used alone or in combination of two or more.

The glass may be prepared by mixing the components of the glass composition, heat-treating them at predetermined temperature or higher, quenching them, and then atomizing them, or by using a gaseous, liquid, or spray pyrolysis method, or the like.

The paste for forming an electrode layer may further include a binder, a solvent, a dispersant, a plasticizer, oxide powder, or the like.

The binder may include, for example, ethylcellulose, acryl, butyral, or the like, and the solvent may include, for example, an organic solvent or an aqueous solvent, such as terpineol, butylcarbitol, alcohol, methyl ethyl ketone, acetone, and toluene.

The content of Ni among the total amount of Ni and the auxiliary element included in the paste for forming an electrode layer may be 80 mol % to 95 mol %. In the above range, as the capacitance characteristics of the multilayer ceramic capacitor 100 is further improved, the connection stability of the internal electrodes 121 and 122 and the external electrodes 131 and 132 may be further improved.

The content of the auxiliary element among the total amount of Ni and the auxiliary element included in the paste for forming an electrode layer may be 5 mol % to 20 mol %. In the above range, as the driving reliability of the multilayer ceramic capacitor 100 is further improved, the deterioration of capacitance characteristics may be suppressed.

As a method of applying the paste for forming an electrode layer to the outer surface of the capacitor body 110, a dip method, various printing methods such as screen printing, a coating method using dispenser or the like, a spraying method using a spray or the like, or the like may be used. The paste for forming an electrode layer may be applied to at least the third surface and the fourth surface of the capacitor body 110, and optionally, may also be applied to a part of the first surface, the second surface, the fifth surface, or the sixth surface where band portions of the first external electrode and the second external electrode are formed.

The sintering may be performed at a temperature of 500° C. to 850° C. In the above range, the alloy of Ni and the auxiliary element may be sufficiently formed, and the connection stability between the internal electrodes 121 and 122 and the external electrodes 131 and 132 may be further improved.

Subsequently, optionally, a paste for forming a conductive resin layer is applied to the outer surface of the capacitor body 110 where the electrode layers 10 and 20 are formed and then cured, to form the conductive resin layer.

The paste for forming a conductive resin layer may include a resin and, optionally, a conductive metal or a non-conductive filler. The description of the conductive metal and resin is the same as described above, and the repeated description will not be included here again. In addition, the paste for forming a conductive resin layer may include, optionally, a binder, a solvent, a dispersant, a plasticizer, oxide powder, or the like. The binder may include, for example, ethylcellulose, acryl, butyral, or the like, and the solvent may include an organic solvent or an aqueous solvent, such as terpineol, butylcarbitol, alcohol, methyl ethyl ketone, acetone, and toluene.

As an example, the conductive resin layer may be formed by dipping the capacitor body 110 into the paste for forming a conductive resin layer and then curing it, or by printing the paste for forming a conductive resin layer on the surface of the capacitor body 110 by a screen printing or gravure printing method or the like, or by applying the paste for forming a conductive resin layer to the surface of the capacitor body 110 and then curing it.

The plating layers 30 and 40 may be formed on outer side of the conductive resin layer.

The plating layers 30 and 40 may be formed by a plating method, and may be formed by sputtering or electric deposition.

Hereinafter, specific examples of the present disclosure will be presented. However, the examples described below are merely for exemplification or description.

### Examples 1 to 12 and Comparative Examples 1 to 6

A dielectric powder was prepared by doping barium titanate (BaTiO₃) as a primary component powder with Sn and Mn by the content described in Table 1 based on 100 parts by mole of barium titanate. Rare-earth elements such as Dy, Tb, Y, Gd, Ho, La, Er, Sm, Nd, or Ce were added to the dielectric powder in the form of oxides.

A dielectric slurry was prepared by mixing the above dielectric powder, Mn₃O₄ as an additive, and a solvent. The input amount of the above additive was adjusted to the content described in Table 1 based on 100 parts by mole of barium titanate.

The dielectric green sheet was prepared by using the dielectric slurry, and the conductive paste layer containing Ni was printed on a surface of the dielectric green sheet. A dielectric material green sheet laminate was prepared by laminating and pressing the dielectric green sheet (Width×Depth×Height=3.2 mm×2.5 mm×2.5 mm) on which the conductive paste layer is formed.

The dielectric material green sheet laminate was calcined at 400° C. or less in a nitrogen atmosphere, and was fired at the temperature (firing temperature) described in Table land a hydrogen concentration of 0.11% H₂, to prepare the capacitor body.

Subsequently, a multilayer ceramic capacitor was manufactured through processes such as external electrode and plating.

### Examples 13 to 24

Except that the hydrogen concentration is 0.56% H₂, the multilayer ceramic capacitors of Examples 13 to 24 were manufactured in the same method as the multilayer ceramic capacitors of Examples 1 to 12, respectively (see Table 2).

### Comparative Examples 7 to 9

Except that the hydrogen concentration is 0.56% H₂, multilayer ceramic capacitors of Comparative Examples 7 to 9 were manufactured in the same method as the multilayer ceramic capacitors of Comparative Examples 1 to 3, respectively (see Table 2).

### Comparative Example 10

Except that the hydrogen concentration is 0.56% H₂, and multilayer ceramic capacitors of Comparative Example 10 was manufactured in the same method as the multilayer ceramic capacitors of Comparative Example 5 (see Table 2).

### Evaluation 1: TEM-EDS and Line Scanning Analysis

The multi-layered ceramic capacitor of the Example 1 were laid down horizontally, and an area around the multi-layered ceramic capacitor was fixed with epoxy resin.

Polishing was performed by a polishing machine so that a cross-section (L-T cross-section) taken along the length direction (L-axis direction) and the stacking direction (W-axis direction) to be perpendicular to the width direction at a center of the multilayer ceramic capacitor in the width direction (W-axis direction) may be exposed.

An active region of the L-T cross-section was divided into 3 parts of an upper portion, a central portion, and a lower portion, and one dielectric layer was selected for each part. For each selected dielectric layer, three dielectric grains were randomly selected (a total of nine dielectric grains were selected). The TEM analysis was performed on the selected dielectric grains, and thereby TEM analysis images were obtained. The TEM analysis was measured at 10k magnification and an accelerating voltage of 200 kV. A linear section extending from one grain boundary of the dielectric grain to another grain boundary and passing through a central point may be set in each of the TEM analysis images, and lengths from the central point of the dielectric grain 111a to the core portion, the first shell portion, the second shell portion, and the grain boundary were measured in the linear section. The lengths of respective one of the measured portion are averaged and evaluated as a final length of the respective measured portion.

Additionally, an EDS mapping analysis and line scanning analysis was perform on the TEM analysis image. The line scanning analysis was performed along the linear section. A device used in the analysis is JEOL's JEM-ARM200F.

In the linear section, a region passing through the central point and having a length of about 40 nm to 160 nm, where the content of Sn and the transition metal and the content of the rare-earth element are smallest together, was evaluated as the core portion. In the linear section, a region in contact with the core portion and having a total length of about 20 nm to 120 nm, where the content of Sn and the transition metal is greatest was evaluated as the first shell portion. In the linear section, a region in contact with the first shell portion and having a total length of about 20 nm to 120 nm, where the content of the rare-earth element is greatest was evaluated as the second shell portion.

In the linear section, a region in contact with the second shell portion and having a total length of approximately 10 nm or less, where the content of Si is greatest was evaluated as a grain portion. The total length of the above-described the first shell portion is a sum of lengths of two first shell portions included in the linear section, the total length of the above-described the second shell portion is a sum of lengths of two second shell portions included in the linear section, and the total length of the above-described grain portion is a sum of lengths of two grain portions included in the linear section.

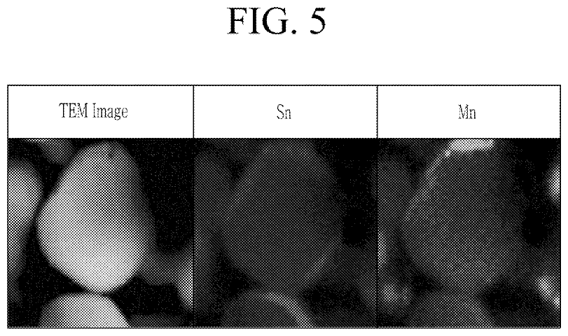

FIG. 5 are TEM-EDS analysis images for the dielectric grains of a multilayer ceramic capacitor according to Example 1.

Referring to FIG. 5, Sn and the transition metal (Mn) was stably distributed on the surface of the core portion of barium titanate.

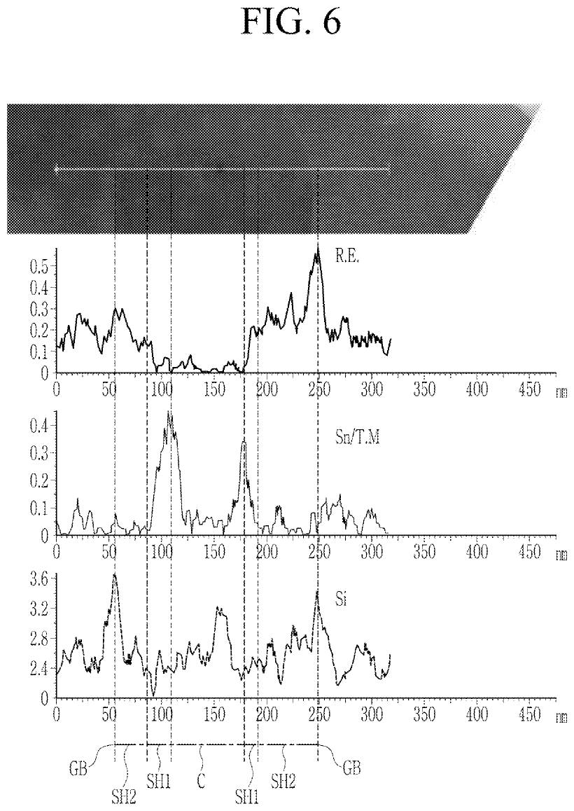

FIG. 6 are TEM analysis image and line scanning analysis result for the dielectric grain of a multilayer ceramic capacitor according to Example 1.

Referring to FIG. 6, it was measured that the content of Sn and the transition metal (Mn) was greatest in the first shell portion SH1, the content of the rare-earth element was greatest in the second shell portion SH2, and the content of Si was greatest in the grain boundary GB. By doping Sn and the transition metal at the step of forming the dielectric powder, the content of Sn and the transition metal was greatest in the first shell portion SH1, but not in the grain boundary GB. Accordingly, the breakdown voltage characteristics and stability of a multilayer ceramic capacitor was improved.

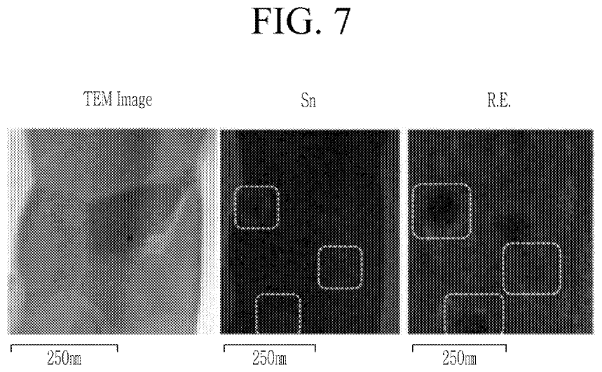

FIG. 7 are TEM-EDS analysis images for the dielectric grain of a multilayer ceramic capacitor according to Example 1.

Referring to FIG. 7, it was confirmed that the second shell portion in which rare-earth elements (R.E.) is dispersed is disposed on the first shell portion in which Sn is dispersed.

### Evaluation 2: Characteristic Analysis of Multilayer Ceramic Capacitors

(Cp, DF, ε, BDV and MTTF analysis)

For the multilayer ceramic capacitors manufactured according to Examples and Comparative Examples, the capacitance (Cp), dissipation factor (DF), room temperature permittivity (ε), breakdown voltage (BDV) and mean time to failure (MTTF) were measured.

In more detail, Cp and DF were measured by using Agilent's capacitance meter (model number: 4268A). ε was converted from the measured Cp by considering the dielectric thickness, number of layers, electrode overlap area, etc. BDV was measured using a Keithley high resistance/low current electrometer (model number: 6430). MTTF was evaluated by measuring the time to failure while maintaining the multilayer ceramic capacitor at a temperature of 125° C. and a voltage of 9.45 V for 48 hours.

The doping amounts, additive amounts, sintering temperatures, Cp, ε, DF, BDV, and MTTF of Examples 1 to 12 and Comparative Examples 1 to 6 are shown in Table 1 below. In Tables 1 and 2, “-” indicates that the component was not added or doped. In Table 1, “All Short” indicates cases where a short circuit occurred during the production of the multilayer ceramic capacitor and evaluation was not possible.

TABLE 1

| | Doping | | Mn₃O₄ | | | | | | |
|---|---|---|---|---|---|---|---|---|---|
| | amount | | Additive | | | | | | |
| | (parts by | | content | | | | | | |
| | mole) | | (parts by | Firing | Cp | | DF | BDV | MTTF |
| | Sn | Mn | mole) | temperature | (μF) | ε | (%) | (V) | (hr) |
| Example 1 | 1.5 | 0.10 | — | 1200 | 2.27 | 2889 | 2.98 | 76 | 24.1 |
| Example 2 | | | | 1210 | 2.31 | 2940 | 3.08 | 71 | 21.1 |
| Example 3 | | | | 1220 | 2.38 | 3029 | 3.24 | 68 | 18.2 |
| Example 4 | 1.0 | 0.15 | — | 1200 | 2.33 | 2965 | 3.12 | 72 | 23.5 |
| Example 5 | | | | 1210 | 2.41 | 3067 | 3.31 | 68 | 20.1 |
| Example 6 | | | | 1220 | 2.47 | 3144 | 3.53 | 62 | 16.4 |
| Example 7 | 1.0 | 0.10 | — | 1200 | 2.68 | 3411 | 3.66 | 63 | 16.2 |
| Example 8 | | | | 1210 | 2.7 | 3436 | 4.19 | 59 | 11.1 |
| Example 9 | | | | 1220 | 2.86 | 3640 | 4.37 | 53 | 11.0 |
| Example 10 | 1.0 | 0.05 | 0.05 | 1200 | 2.76 | 3513 | 3.49 | 60 | 14.1 |
| Example 11 | | | | 1210 | 2.81 | 3576 | 4.53 | 54 | 11.6 |
| Example 12 | | | | 1220 | 2.94 | 3742 | 4.96 | 46 | 8.5 |
| Comparative | 1.0 | — | 0.10 | 1200 | 2.67 | 3398 | 3.75 | 49 | 13.2 |
| Example 1 | | | | | | | | | |
| Comparative | | | | 1210 | 2.85 | 3627 | 4.63 | 48 | 8.7 |
| Example 2 | | | | | | | | | |
| Comparative | | | | 1220 | 2.93 | 3729 | 4.90 | 36 | 4.6 |
| Example 3 | | | | | | | | | |
| Comparative | — | — | 0.10 | 1190 | 2.89 | 3678 | 4.87 | 36 | 4.1 |
| Example 4 | | | | | | | | | |
| Comparative | | | | 1200 | 3.01 | 3831 | 5.16 | 24 | 3.6 |
| Example 5 | | | | | | | | | |
| Comparative | | | | 1210 | All Short | | | | |
| Example 6 | | | | | | | | | |

The doping amounts, additive amounts, sintering temperatures, Cp, ε, DF, BDV, and MTTF of Examples 13 to 24 and Comparative Examples 7 to 10 are shown in Table 2 below.

TABLE 2

| | Doping | | Mn₃O₄ | | | | | | |
|---|---|---|---|---|---|---|---|---|---|
| | amount | | Additive | | | | | | |
| | (parts by | | content | | | | | | |
| | mole) | | (parts by | Firing | Cp | | DF | BDV | MTTF |
| | Sn | Mn | mole) | temperature | (μF) | ε | (%) | (V) | (hr) |
| Example 13 | 1.5 | 0.10 | — | 1200 | 2.34 | 2979 | 4.81 | 66 | 28.4 |
| Example 14 | | | | 1210 | 2.45 | 3112 | 4.96 | 61 | 26.1 |
| Example 15 | | | | 1220 | 2.56 | 3261 | 5.01 | 60 | 20.7 |
| Example 16 | 1.0 | 0.15 | — | 1200 | 2.55 | 3242 | 4.92 | 60 | 26.8 |
| Example 17 | | | | 1210 | 2.56 | 3252 | 5.04 | 55 | 22.4 |
| Example 18 | | | | 1220 | 2.66 | 3387 | 5.24 | 51 | 19.7 |
| Example 19 | 1.0 | 0.10 | — | 1200 | 2.51 | 3195 | 5.13 | 58 | 26.7 |
| Example 20 | | | | 1210 | 2.8 | 3564 | 5.46 | 54 | 18.7 |
| Example 21 | | | | 1220 | 2.89 | 3678 | 5.99 | 46 | 13.6 |
| Example 22 | 1.0 | 0.05 | 0.05 | 1200 | 2.52 | 3207 | 5.29 | 54 | 24.3 |
| Example 23 | | | | 1210 | 2.73 | 3475 | 5.64 | 49 | 15.3 |
| Example 24 | | | | 1220 | 2.97 | 3780 | 6.13 | 46 | 11.1 |
| Comparative | 1.0 | — | 0.10 | 1200 | 2.64 | 3360 | 5.19 | 46 | 22.5 |
| Example 7 | | | | | | | | | |
| Comparative | | | | 1210 | 2.72 | 3462 | 5.81 | 41 | 13.6 |
| Example 8 | | | | | | | | | |
| Comparative | | | | 1220 | 3.03 | 3856 | 6.12 | 26 | 9.8 |
| Example 9 | | | | | | | | | |
| Comparative | — | — | 0.10 | 1200 | 2.89 | 3678 | 4.87 | 36 | 4.1 |
| Example 10 | | | | | | | | | |

Referring to Tables 1 and 2, by doping Sn and the transition metal (Mn) together into barium titanate, in the embodiments where the first shell portion containing Sn and the transition metal is formed in the core portion containing the barium titanate-based compound, the breakdown voltage characteristics and driving stability were improved while maintaining the capacitance characteristics and permittivity at a similar level to Comparative Examples.

### DESCRIPTION OF SYMBOLS

100: multilayer ceramic capacitor
110: capacitor body
111: dielectric layer
111a: dielectric grain
121: first internal electrode layer
122: second internal electrode layer
131: first external electrode
132: second external electrode
GB: grain boundary
C: core portion
SH1: first shell portion
SH2: second shell portion
SH3: third shell portion

What is claimed is:

1. A multilayer ceramic capacitor, comprising:
a capacitor body comprising a dielectric layer and an internal electrode layer; and
an external electrode disposed on an outer surface of the capacitor body,
wherein:
the dielectric layer comprises a plurality of dielectric grains and a grain boundary disposed between the plurality of dielectric grains;
the dielectric layer comprises Sn and a transition metal;
at least one of the plurality of dielectric grains has a core-shell structure comprising a core portion, a first shell portion disposed on at least a portion of the core portion, and a second shell portion disposed on at least a portion of the first shell portion; and
a content of Sn and a content of the transition metal are largest in the first shell portion among the core portion, the first shell portion, the second shell portion, and the grain boundary.

2. The multilayer ceramic capacitor of claim 1, wherein in a linear section from a center of at least one of the plurality of dielectric grains having the core-shell structure to the grain boundary:
a length of the core portion is 20 nm to 80 nm;
a length of the first shell portion is 10 nm to 60 nm;
a length of the second shell portion is 10 nm to 60 nm; and
a length of the grain boundary is 5 nm or less.

3. The multilayer ceramic capacitor of claim 1, wherein, in a linear section extending from a first grain boundary to a second grain boundary and passing through the center of at least one of the plurality of dielectric grains having the core-shell structure, Equations 1 to 3 are satisfied:
$$0.85 a \leq b + c \leq 1.15 a \qquad [ Equation 1 ]$$
$$0.1 a \leq b \leq 0 \text{.9} a \qquad [ Equation 2 ]$$
$$0.1 a \leq c \underline{<} 0 \text{.9} a \qquad [ Equation 3 ]$$
where, a is a length from the first grain boundary to the second grain boundary, b is a length corresponding to the core portion in the linear section, and c is a total length of the second shell portion in the linear section.

4. The multilayer ceramic capacitor of claim 1, wherein the transition metal included in the dielectric layer comprises at least one selected from the group consisting of Mn, V, Cr, Ta, Sc, Ti, Fe, Co, Ni, Cu and Zn.

5. The multilayer ceramic capacitor of claim 1, wherein the dielectric layer further comprises one or more selected from the group consisting of rare-earth elements and Si.

6. The multilayer ceramic capacitor of claim 5, wherein:
the dielectric layer comprises the rare-earth element; and
a content of the rare-earth element is largest in the second shell portion among the core portion, the first shell portion, the second shell portion, and the grain boundary.

7. The multilayer ceramic capacitor of claim 5, wherein:
the dielectric layer comprises Si; and
the content of Si is largest in the grain boundary among the core portion, the first shell portion, the second shell portion, and the grain boundary.

8. The multilayer ceramic capacitor of claim 1, wherein a content of the transition metal included in the first shell portion is 1.2 times or more of a content of the transition metal included in the grain boundary.

9. The multilayer ceramic capacitor of claim 1, wherein the dielectric grain having the core-shell structure further comprises a third shell portion disposed on at least a portion of the second shell portion.

10. The multilayer ceramic capacitor of claim 9, wherein a content of the transition metal included in the third shell portion is 0.01 times to 0.2 times of a content of the transition metal included in the first shell portion.

11. The multilayer ceramic capacitor of claim 9, wherein the dielectric layer further comprises one or more selected from among rare-earth elements and Si.

12. The multilayer ceramic capacitor of claim 11, wherein:
the dielectric layer comprises the rare-earth element; and
a content of the rare-earth element included in the third shell portion is 0.01 times to 0.2 times of a content of the rare-earth element included in the second shell portion.

13. The multilayer ceramic capacitor of claim 11, wherein:
the dielectric layer comprises the rare-earth element; and
a content of the rare-earth element included in the grain boundary is 1.3 times or more of a content of the rare-earth element included in the third shell portion.

14. The multilayer ceramic capacitor of claim 1, wherein an average thickness of the dielectric layer is greater than 0 μm and less than or equal to 0.7 μm.

15. The multilayer ceramic capacitor of claim 1, wherein an average thickness of the dielectric layer is greater than 0 μm and less than or equal to 0.65 μm.

16. A manufacturing method of the multilayer ceramic capacitor of claim 1, comprising:
manufacturing a dielectric powder doped with Sn and the transition metal in a barium titanate-based compound;
manufacturing a dielectric slurry comprising the dielectric powder;
manufacturing a dielectric green sheet by using the dielectric slurry, and forming a conductive paste layer on the dielectric green sheet surface;
manufacturing a dielectric material green sheet laminate by stacking the dielectric green sheet on which the conductive paste layer is formed;
manufacturing the capacitor body comprising the dielectric layer and the internal electrode layer by firing the dielectric material green sheet laminate; and
forming the external electrode on a first surface of the capacitor body.

17. The manufacturing method of claim 16, wherein a doping amount of Sn is 0.1 parts by mole to 5 parts by mole based on the 100 parts by mole of the barium titanate-based compound.

18. The manufacturing method of claim 16, wherein a doping amount of the transition metal is 0.01 parts by mole to 0.5 parts by mole based on the 100 parts by mole of the barium titanate-based compound.

19. The manufacturing method of claim 16, wherein the dielectric slurry further comprises a transition metal-containing compound.

20. The manufacturing method of claim 16, wherein a rare-earth element is further doped into the barium titanate-based compound.
